(19) United States
(12) Patent Application Publication
(10) Pub. No.: US 2014/0156388 A1
(43) Pub. Date: Jun. 5, 2014

(54) TRACKING DEAL PROVIDER PERFORMANCE

(71) Applicant: Visa International Service Association, San Francisco, CA (US)

(72) Inventor: Michelle Winters, Foster City, CA (US)

(73) Assignee: Visa International Service Association, San Francisco, CA (US)

(21) Appl. No.: 13/900,128

(22) Filed: May 22, 2013

Related U.S. Application Data
(60) Provisional application No. 61/733,316, filed on Dec. 4, 2012.

(51) Int. Cl. G06Q 30/02

(52) U.S. Cl. CPC G06Q 30/0246
USPC 705/14.45

(57) ABSTRACT

The examples described herein establish metrics for monitoring the performance of deal provider websites. In one example, an apparatus processes a first plurality of payment requests received from at least one of a plurality of deal providers and generates a first plurality of transaction data records storing the transaction data and payment numbers. The apparatus associates a merchant providing a particular one of the deals with each of the first plurality of transaction data records, and processes a second plurality of payment requests received from at least one of the merchants and including at least one of the payment numbers. The apparatus generates a second plurality of transaction data records storing transaction data from each of the second plurality of payment requests. The apparatus filters the second plurality of transaction data records based on a category filter and generates a deal provider metric.

### CROSS REFERENCE TO RELATED APPLICATIONS

This application claims the benefit of, and priority to, U.S. Provisional Patent Appl. Ser. No. 61/733,316, filed Dec. 4, 2012, titled “Systems and Methods for Tracking Deal Provider Performance,” the content of which is incorporated herein by reference in its entirety.

### BACKGROUND OF THE INVENTION

1. Field of the Invention

The invention relates to systems and methods for tracking and reporting deal provider performance. Among other fields and applications, the invention has utility in assessing effectiveness in listing deals with competing deal provider websites.

2. Description of Related Art

The digital marketplace continues to expand and includes many deal providers with websites offering deals for goods and services. Example websites include Groupon, LivingSocial, Google Offers, Yelp, and Amazon Local. Merchants sign up with these deal providers and offer a deal on a product or service to entice customers to patronize their business. To learn of the deals, customers may browse the websites or sign up to periodically receive alerts. Customers may purchase a deal, and oftentimes are issued a voucher to be redeemed at the merchant.

Merchants may use a deal website with hopes of expanding their business and acquiring new customers. Merchants, however, may not obtain the desired benefit. In some instances, an unacceptably large percentage of customers who purchase a deal may not make a subsequent purchase from the merchant. Merchants incur other costs when listing a deal with a deal provider website. For instance, fees charged by deal providers to list on their websites may be expensive. Also, merchants may offer too many deals that are redeemed to the detriment of their finances and their existing customer base.

As a result of the foregoing, a need exists to provide merchants with information to better use deal provider websites.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 shows a block diagram illustrating example aspects of a system for determining at least one metric for comparing performance of deal providers in accordance with example embodiments.

FIG. 2 illustrates an example signaling flow diagram showing communications within a system for purchasing a deal from a deal provider website in accordance with example embodiments.

FIG. 3 illustrates an example database table including transaction data records in accordance with example embodiments.

FIG. 4 illustrates a flow chart of a payment network server processing payment authorization requests in accordance with example embodiments.

FIG. 5 illustrates a flow chart of communications between devices for searching for metrics in accordance with example embodiments.

FIG. 6 illustrates a search query graphical user interface (GUI) in accordance with example embodiments.

FIG. 7 illustrates a metrics graphical user interface (GUI) in accordance with example embodiments.

FIG. 8 illustrates a flow diagram of a method for generating a metric in accordance with example embodiments.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

A system, apparatus, computer readable media, and method are disclosed for generating deal provider metrics to enable a merchant to compare performance of one deal provider relative to at least one other deal provider. Specifically programmed computer hardware may generate such metrics based on analyzing and computer processing of payment transaction data. In some examples, the specifically programmed computer hardware may be hardwired to perform functionality described herein, may include one or more specifically programmed software modules executing specialized computer instructions to perform functionality described herein, and/or combinations thereof.

In an example, a first plurality of payment requests received from at least one of a plurality of deal providers is processed, wherein each of the requests comprises transaction data associated with a deal listed by one of the deal providers and a payment number associated with a customer. A first plurality of transaction data records is generated storing the transaction data and the payment numbers. A merchant providing a particular one of the deals via a particular one of the deal providers is associated with each of the first plurality of transaction data records. A second plurality of payment requests received from at least one of the merchants and including at least one of the payment numbers is processed. A second plurality of transaction data records is generated storing transaction data from each of the second plurality of payment requests. The second plurality of transaction data records are filtered based on a category filter. A metric is generated for at least one of the deal providers based on transaction data obtained from the filtered transaction data records.

### DETAILED DESCRIPTION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

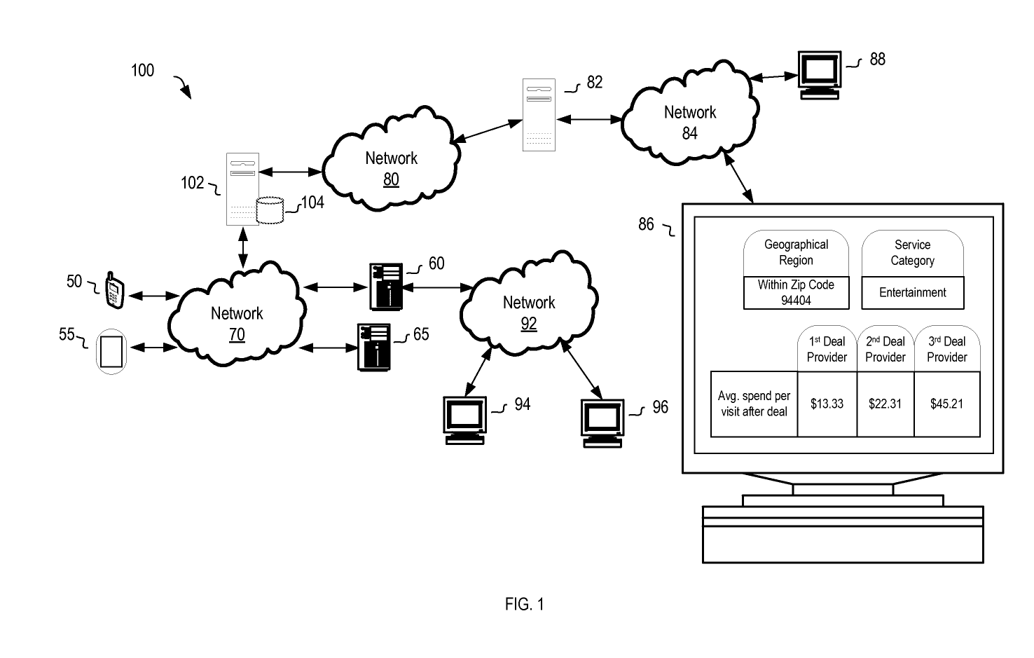

FIG. 1 illustrates a block diagram of a system 100 for tracking of deal provider performance in accordance with example embodiments. System 100 may include one or more client terminals 50, 55, one or more deal provider servers 60, 65, one or more payment network servers 102, one or more merchant servers 82, one or more merchant point of sale terminals 88, one or more merchant user terminals 86, and one or more deal provider user terminals 94, 96. Networks 70, 80, 84, and 92 are shown interconnecting various components. Networks 70, 80, 84, and 92 may be the Internet, WAN, LAN, Wi-Fi, other computer network (now known or invented in the future) as well as any combination of the foregoing. It should be understood by those of ordinary skill in the art having the present specification, drawings, and claims before them that networks 70, 80, 84, and 92 may connect the various components over any combination of wired and wireless conduits, including copper, fiber optic, microwaves, and other forms of radio frequency, electrical and/or optical communication techniques. It should also be understood that each provider's network may be connected to any of networks 70, 80, 84, and 92 differently. The interconnections between devices in system 100 are examples. Any device depicted in FIG. 1 may communicate with any other device via one or more of the networks 70, 80, 84, and 92.

System 100 may include additional devices and networks beyond those shown. Further, the functionality described as being performed by one device may be distributed and performed by two or more devices. Multiple devices shown in FIG. 1 may also be combined into a single device, which may perform the functionality of the combined devices.

Servers 60, 65, 82, and 102 may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. Servers 60, 65, 82, and 102 may be running on any one of many operating systems including, but not limited to WINDOWS, UNIX, LINUX, MAC OS, or Windows (XP, VISTA, etc.). It is contemplated, however, that any suitable operating system may be used for the present invention. Servers 60, 65, 82, and 102 may be one or may be a cluster of web servers, which may each be LINUX based and supported by a load balancer that decides which of the cluster of web server should process a request based upon the current request-load of the available server(s).

Terminals 50, 55, 86, 88, 94, and 96 may be general purpose computers that may have, among other elements, a microprocessor (such as from the Intel Corporation or AMD); volatile and non-volatile memory; one or more mass storage devices (i.e., a hard drive); various user input devices, such as a mouse, a keyboard, or a microphone; and a video display system. Examples of terminals include tablets, mobile phones, smart phones, computers, laptops, and the like. In one aspect, the general-purpose computer may be controlled by the WINDOWS (XP, VISTA, etc.) operating system. It is contemplated, however, that the present system would work equally well using a MACINTOSH computer or even another operating system such as a UNIX, LINUX, MAC OS, or a JAVA based operating system, to name a few.

Terminals 50, 55, 86, 88, 94, and 96 may operably connect to servers 60, 65, 82, and 102, respectively, via one of many available internet browsers including, but not limited to, Microsoft's Internet Explorer, Apple's Safari, and Mozilla's Firefox. Via any of networks 70, 80, 84, or 92, the end users may access the system 100 with, for example, an http-based or https-based website, although other graphical user interfaces can be used with the present system. The information entered by an end user via terminals 50, 55, 86, 88, 94, and 96 may be encrypted before transmission over a network for security. There are several commercially available encryption programs or algorithms available including, but not limited to, PC1 Encryption Algorithm, TrueCrypt, a Symantec encryption program, Blowfish, and Guardian Edge.

Deal provider servers 60, 65 may provide a digital marketplace through which merchants may list deals on products and/or services. In an example, deal provider servers 60, 65 may host websites that can be accessed by client terminals 50, 55 via network 70. The websites may list deals on products and/or services that are available from the merchants. Some of the deals may offers products and/or services at a discounted price to entice customers to make purchases from the merchants. Merchants may also pay a fee to list their deal on the deal provider website. A merchant's goal when listing a discount for a product/service with the deal provider website is to attract new business and/or to increase sales. There are many different deal providers each with their own website. Conventionally, deal providers have not provided merchants with information indicating how effective their website is compared to competing deal providers.

To enable merchants to assess how effective listing a deal with a particular one of the deal provider websites is, payment network server 102 may monitor customer purchases of deals from the deal provider websites, and subsequent purchases from merchants who listed the deals on the websites. System 100 may determine one or more metrics for assessing performance of the deal provider websites based on the effect on a merchant's sales relative to when the deal was offered. Payment network server 102 may also provide metrics on multiple merchant categories to enable merchants to select with which deal provider to list their deals.

For example, payment network server 102 may include specifically programmed computer hardware performing the functions described herein. Examples of the specifically programmed computer hardware include a display/report generator, an analytical engine, and memory. In some examples, the specifically programmed computer hardware may be hardwired to perform functionality described herein, may include one or more specifically programmed software modules executing specialized computer instructions to perform functionality described herein, and/or combinations thereof.

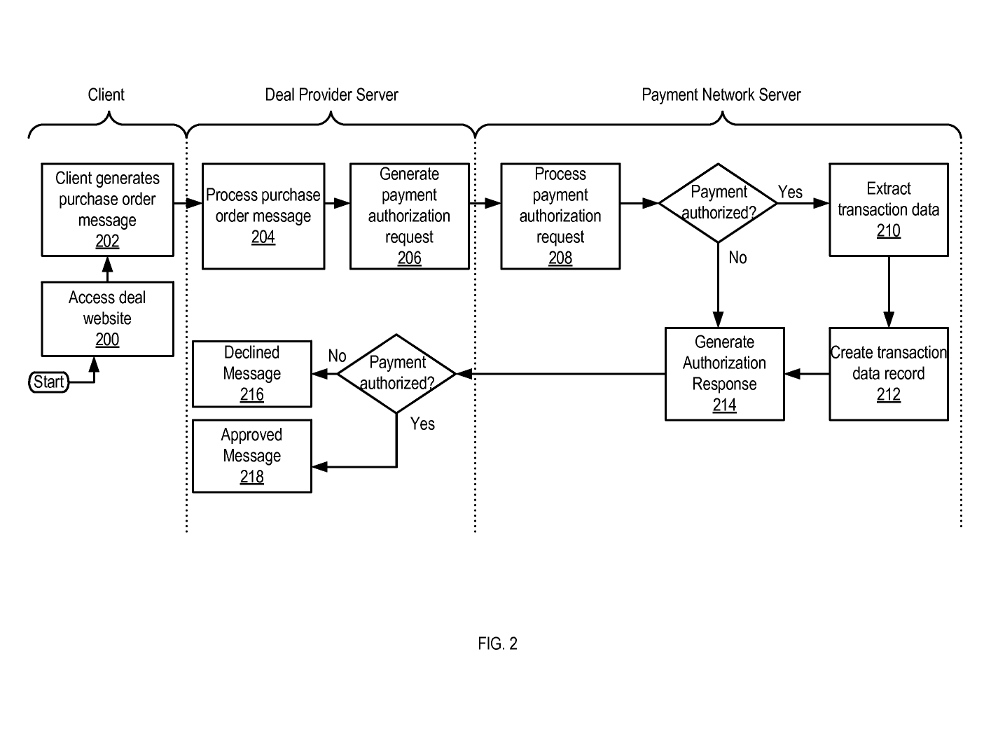

FIG. 2 illustrates an example signaling flow diagram showing communications within system 100 for purchasing a deal from a deal provider website in accordance with example embodiments. In an example, a customer may, in block 200, use client terminal 50 to access a deal website from deal provider server 60. The client terminal 50 may be a computer, a smart phone, a tablet computer, or other device for communicating via a network. The deal provider server 60 may be a webserver or other device configured to provide a website to the client terminal 50. The customer may select a particular deal and may provide payment information. Payment information may include, for example, a payment number (e.g., credit card number, a 16 digit personal account number (PAN), a near field communication (NFC) credential, etc.), billing address of the customer, and a card verification value (e.g., CVV2 number) for a credit card. Client terminal 50 may communicate a purchase order message including the payment information to deal provider server 60.

Subsequent to receipt, deal provider server 60 may, in block 204, process the purchase order message. Server 60 may, in block 206, generate and communicate a payment authorization request to a payment network server 102. In an example, payment network server 102 may be operated by a financial services corporation that facilitates electronic funds transfers. An example of such a financial services corporation is VISA Inc. In another example, an issuer could deploy the payment network server 102 for tracking purchases of its cardholders. Additionally, deal provider may have an agreement with an acquirer that handles their payment processing. An acquirer server, instead of a deal provider server, may communicate with payment network server 102. Payment network server 102 may, in block 208, process the payment authorization request to authorize or decline the request, and respond to deal provider server 60 accordingly. Further, payment network server 102 may also communicate with a server of an issuer as part of the authorization process. Payment network server 102 may also facilitate funds transfers between a bank associated with the customer and a bank associated with the deal provider.

If payment is authorized, payment network server 102 may, in block 210, extract the transaction data from the request and create a transaction data record in block 212. In an example, payment network server 102 may include a database 104 or other storage device storing transaction data records that include data on at least some transactions that have been authorized. Database 104 may be any suitable database or databases including, but not limited to, SQL databases (by Microsoft and others), Oracle databases, 4^{th} Dimension databases, InterBase databases, and Apache databases. While depicted as a single database, it should be understood by those of ordinary skill in the art having the present specification, drawings, and claims before them that the database 104 may be stored in multiple locations and across multiple pieces of hardware, including but not limited to storage in the cloud (i.e., a set of virtual storage areas and systems that expand and contract with use without requiring the manual provisioning or deprovisioning of physical hardware by the administrator). In view of the sensitivity and/or commercial significance of most of the data stored in the databases they are preferably secured in an attempt to minimize the risk of undesired disclosure of viewer information to third parties. The databases may be standard relational database systems such as those available from Oracle.

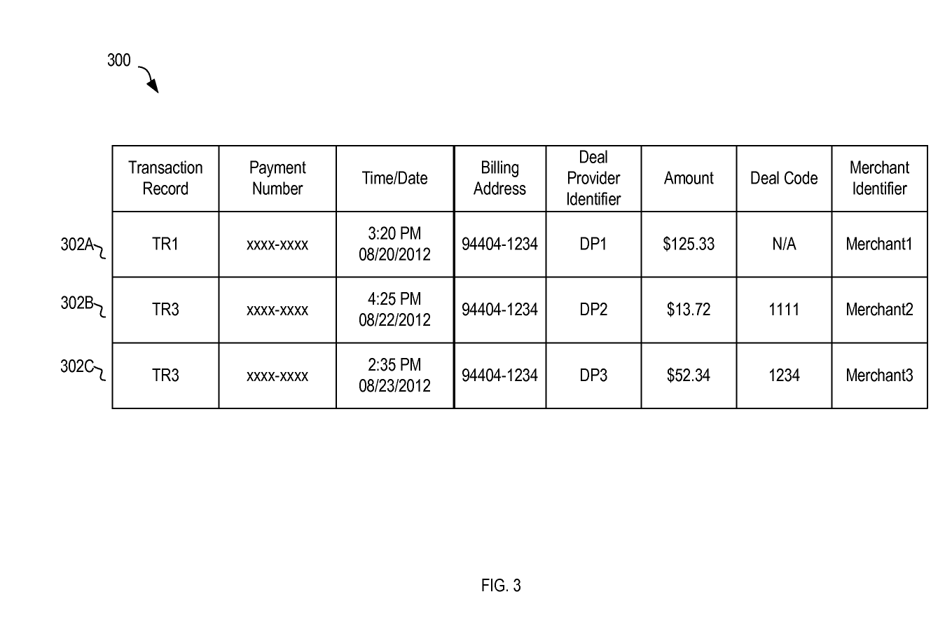

Payment network server 102 may create a unique transaction data record for each payment that is authorized. FIG. 3 illustrates a database table 300 including transaction data records 300 in accordance with example embodiments. Table 300 may include one or more records 302, with records 302A-C being shown in the depicted example. Each record 302 entry may include fields identifying one or more of a payment number (e.g., credit card number), a time and/or date of a transaction, a billing address (e.g., ZIP+4 information), a deal provider identifier, an amount of the transaction, a deal code, and a merchant identifier. In another example, records 302 may include a unique identifier instead of the payment number to reduce the possibility of exposing the payment number. A lookup table may be used to associate the unique identifier with the payment number. Additionally, not all fields in each record may have a value.

The deal code may be a unique identifier of a deal included in the payment authorization request to permit payment network computer 102 to uniquely identify the deal as well as a merchant identifier for a merchant who listed the deal with the deal provider. For example, deal provider server 60 may have a direct or separate connection outside of the payment authorization communication stream to payment network server 102 providing deal codes and/or other information describing deals that have been purchased by consumers from the deal provider websites. Deal provider server 60 may push this information to payment network server 102 and/or payment network server 102 may request deal code and/or other deal information.

Deal providers may or might not provide unique identifying information regarding the deal or deals purchased by the customer, such as a deal code. In some instances, a payment authorization request might not include the deal code and instead may only provide a payment number, a time/date of the transaction, ZIP+4 information for the billing address, deal provider identifier, and an amount of the transaction. Even with this limited information, payment network server 102 may attempt to deduce what deal a customer purchased from a deal provider website. In particular, payment network server 102 may use the identified transaction information to determine which deal was acquired from the deal provider. For example, subsequent to the payment authorization request being received, payment network server 102 may access the website of the deal provider associated with the deal provider identifier from the request. Payment network computer 102 may identify all deals available at the transaction amount included in the request. If there are multiple deals available at that amount, payment network server 102 may then apply one or more filters to deduce which offer the customer purchased. The filters may be based on geographic zone of previous purchases using the same payment number, geographic location near to the billing address (e.g., within a predetermined number of miles of the ZIP+4), and purchase history using the same payment number. Payment network computer 102 may then use this information attempting to uniquely associate the payment authorization request with a particular merchant. If uniquely associated, payment network server 102 may include the corresponding merchant identifier in the transaction record 302.

Referring again to FIG. 2, in block 214, payment network server 102 may generate and communicate an authorization response message to deal provider server 60. The authorization response message may indicate whether payment for the deal was approved or declined. If payment network server 102 declined to authorize payment, deal provider server 60 may then, in block 216, communicate a declined message to client terminal 50. In block 218, deal provider server 60 may communicate an approved message if payment network server 102 authorized payment. The approved message may include a voucher, gift certificate, and the like, that is redeemable for at least one of a product and service from a merchant. The customer may subsequently redeem the voucher at the merchant.

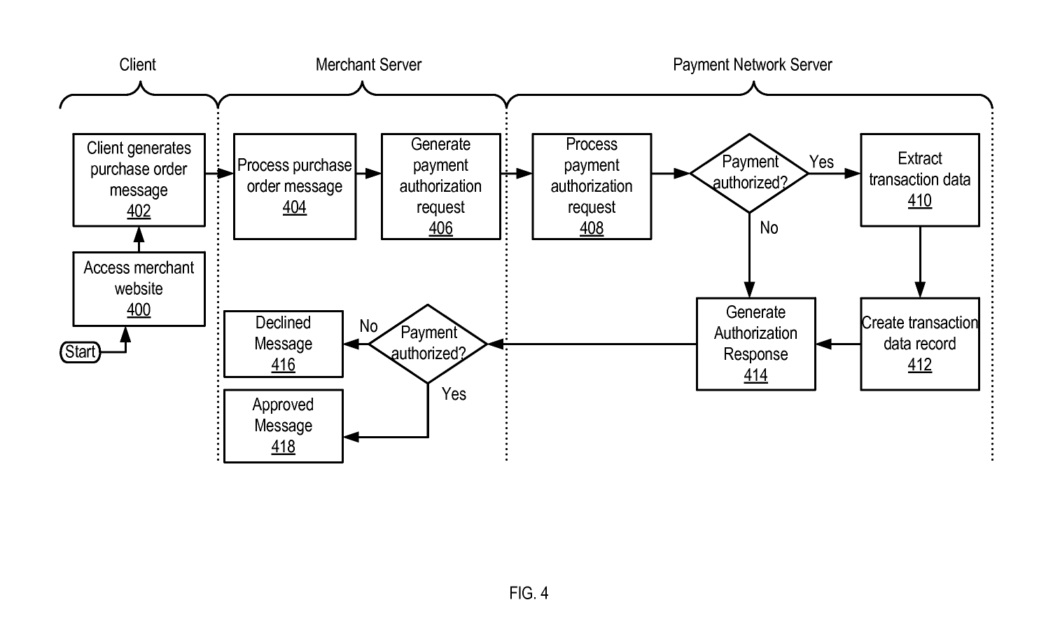

Merchants may use deal provider websites with the goal of acquiring new customers. To determine whether this goal is actually being achieved, payment network server 102 may monitor payment authorization requests originating from merchants, in addition to payment authorization requests received from deal providers, to determine whether customers who purchase deals from a particular deal provider become recurring customers of the merchant. FIG. 4 illustrates a flow chart of a payment network server 102 processing payment authorization requests received from a merchant server 82 in accordance with example embodiments. The example embodiment of FIG. 4 describes a customer making a purchase via a merchant's website. In other examples, payment authorization requests may instead originate from a merchant's point of sale terminal.

With reference to block 400, client terminal 55 may access a website of a merchant. Client 55 may identify a product and/or service to purchase, and may, in block 402, communicate a purchase order message to merchant server 82. The purchase order message may include at least a payment number (e.g., credit card number) of a customer, a merchant identifier, and an amount. Merchant server 82 may process the purchase order message and may communicate, in block 406, a payment authorization request to payment network server 102. Payment network server 102 may, in block 408, process the request and determine whether payment is authorized. If authorized, payment network server 102 may extract transaction data from the request in block 410 and create a transaction record in block 412, in a manner similar to that discussed above with reference to FIG. 2. In block 414, payment network server 102 may generate an authorization response indicating whether payment is approved. If payment is declined, merchant server 82 may communicate a declined message to client 55 in block 416. If payment is declined, merchant server 82 may communicate an approved message to client 65 in block 418.

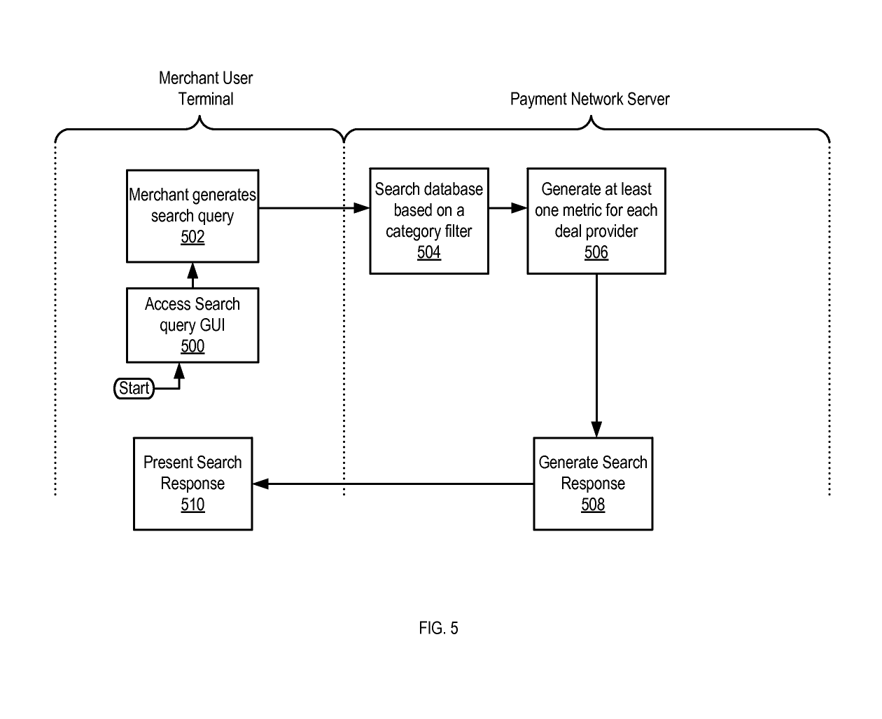

Payment network server 102 may be used to generate metrics based on analyzing transaction data records generated based on purchases originating from deal providers and transaction data records generated based on purchases originating from merchants who have placed deals with these deal providers. Merchants may use the resulting metrics to determine which of the deal providers is most suitable for converting potential customers into recurring customers of the merchants. Deal providers may use the metrics to tout their services of converting new customers into recurring customers. FIG. 5 illustrates a flow chart of communications between devices for searching for metrics in accordance with example embodiments. Starting at block 500, a user of merchant user terminal 86 may access a search query GUI (e.g., website) provided by payment network server 102 and may generate a search query. The merchant user may be a representative of a single merchant, or may be a representative of an association or group of merchants.

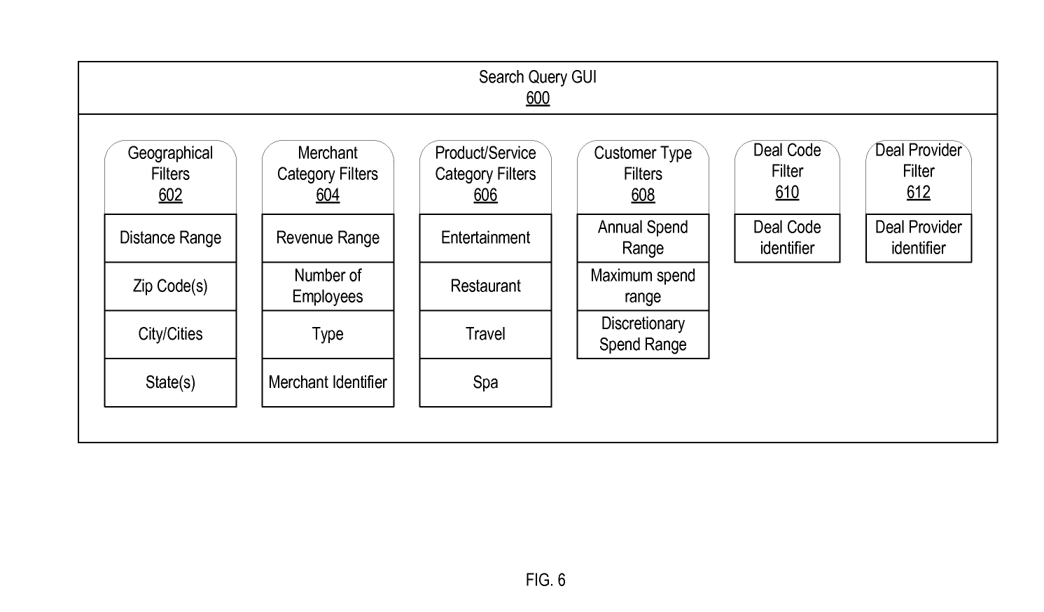

FIG. 6 illustrates a search query GUI in accordance with example embodiments. Search query GUI may include multiple filters having values that may be set by the user. A user may provide desired values to obtain metrics on themselves and/or on merchants within a particular category. In a first example, a merchant may list the same deal on multiple deal provider websites, and may request metrics to determine relative performance between the deal provider websites. In a second example, a merchant that is a small business may desire to obtain metrics on how deal providers have performed when offering deals from similarly sized small businesses. Similarly, merchants may want to know whether different types of offers are more successful than others. In a third example, a merchant may desire to enter a new line of business and may desire to know how deal providers have performed when offering deals from other merchants in that potential new line of business.

With reference to FIG. 6, search query GUI 400 may include fields 602, 604, 606, 608, 610, and 612 each including one or more filters that may be selected by the user. In an example, geographical filters 602 may be set to (1) a distance range from a particular geographic location (e.g., within 10 miles of area code 94404), (2) one or more zip codes (e.g., zip codes 94404, 60606, etc.), (3) one or more cities (e.g., Foster City, Calif. or San Francisco, Calif.), and (4) one or more states (e.g., California, Illinois). Merchant category filters 604 may be set to (1) merchants with a particular estimated revenue range (e.g., $2,000-$4,999.99 per month, $5,000-$10,000 per month, etc.), (2) number of employees (e.g., 1-49 employees, 50-99, 100-199, etc.), (3) type of merchant (e.g., retailer, department store, franchisee, independent, etc.), and (4) merchant identifier (e.g., name of merchant, unique identifier of merchant, etc.). Product/service category filters 606 may be set to, for example, (1) entertainment, (2) restaurant, (3) travel, and (4) spa. Customer type filters 608 may be set to (1) average annual spend range (e.g., $500-$999, $1,000-$2,499, $2,500-$4,999, etc.), maximum spend range (e.g., $0-999, $1,000-$3,000, etc.), and discretionary spend range (e.g., $500-$999, $1,000-$2,499, $2,500-$4,999, etc.). Deal code filters 610 permit a user to specify one or more deal codes to track how particular deals have performed. Deal Provider filter 612 permits a user to specify which deal providers they wish to consider. Other filters instead of or in an addition to those specified above may also be used, and a user need not provide a value for every one of filters 602, 604, 606, 608, 610, and 612. For example, a date range filter may be used to limit metrics for a particular range of dates (e.g., black Friday, all of February, first week in December, memorial day weekend, etc.) so that a merchant may assess deal provider performance around a date range of interest. Other time periods may also be compared (e.g., Saturday morning of one week to Saturday morning of a different week).

Once values have been specified for one or more filters, merchant user terminal 86 may, in block 502 of FIG. 5, generate and communicate a search query to payment network server 102. The search query may include each of the selected filters with the values specified by the user. An example search query includes a geographical filter of “within zip code 94404,” a merchant category filter of “revenue range of $5,000-$10,000 per month,” a product/service category filter of “entertainment,” and no customer type filter.

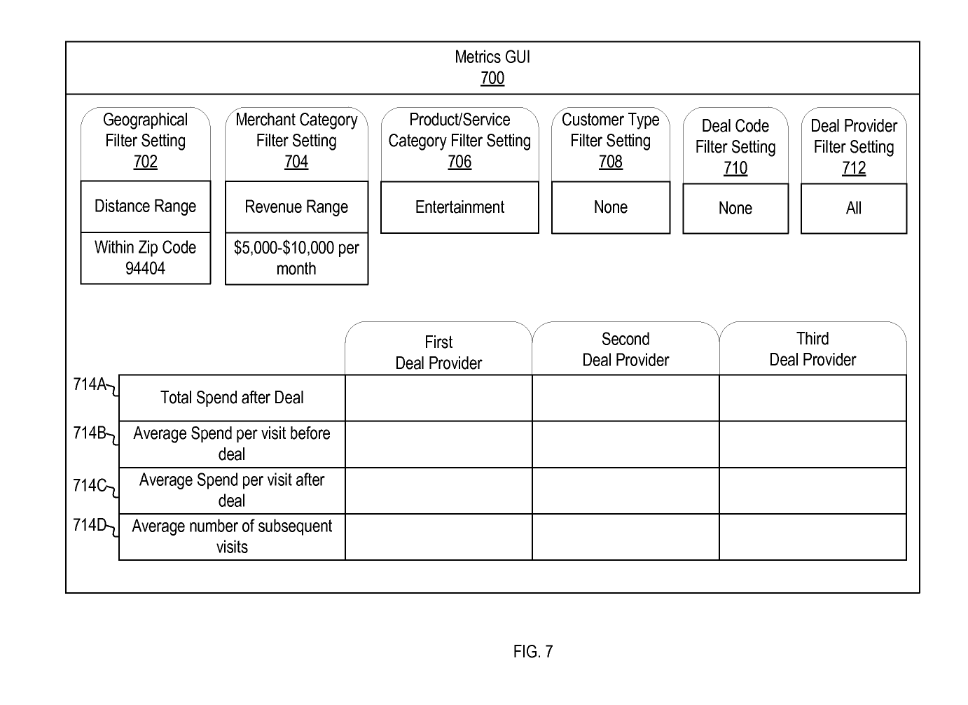

Payment network server 102 may, in block 504, filter the transaction records using the selected filters with the values specified by the user to retrieve matching transaction records. For example, payment network server 102 may retrieve all of the transaction records that include a particular merchant identifier for customers having a billing address within a particular geographic location (e.g., ZIP+4 information, city, state, etc.). Payment network server 102 may, in block 506, generate at least one metric for one or more of the deal providers based on transaction data obtained from the filtered transaction data records. Payment network server 102 may, in block 508, generate a search response including the at least one metric, and merchant user terminal 86 may, in block 510, present the at least one metric in a metrics graphical user interface (GUI), as shown in FIG. 7. The output may be presented by itself or combined with the outputs of other analyses to form a dashboard of metrics (not shown) that may be useful and/or interesting to merchants in operating their businesses. Entities in addition to or other than merchants may use the GUIs depicted in FIGS. 6-7, as well as the other functionality of the example embodiments, to obtain the metrics and data described herein. Payment network server 102 may also be programmed to return null data or an error message if the results of the query would result in data too specific to one or more particular merchants and/or could be used to glean information too specific to particular consumers. In other words, payment network server 102 may restrict reports and displays that may generated to protect the anonymity and maintain aggregated metric data to prevent one competitor from learning too much information about another competitor and/or any one of their customers.

The metrics GUI 700 may identify filter settings 702, 704, 706, 708, 710, and 712 as specified by the user in the Search Query GUI 600, and one or more metrics 714. Metrics GUI 700 may provide a side-by-side comparison of metrics for one or more deal provider websites. As seen in FIG. 7, metrics 714A-D are provided for three different deal providers. In an example, metric 714A identifies a total spend of all customers who purchased a deal subsequent to a transaction date of the deal. Metric 714B identifies an average spend per visit by all customers who purchased a deal prior to a transaction date of the deal. Metric 714C identifies an average spend per visit by all customers who purchased a deal after a transaction date of the deal. Metric 714D identifies an average number of visits by all customers who purchased a deal subsequent to a transaction date of the deal. Other metrics in addition to or instead of metrics 714A-D may also be presented. Metrics may be presented as a chart, graph, or in other manners. Each of these graphical representation may be presented by themselves or combined with other representations to form a dashboard of metrics (not shown). These metrics may also be combined with other information in a dashboard. Instead of presenting metrics data in a GUI, a paper report may be provided to the merchant in hard copy and/or via electronic communication in PDF or other format.

A user may modify any of filter settings 702, 704, 706, 708, 710, and 712, and in response, merchant user terminal 86 may generate and communicate a new search query to payment network server 102. Payment network server 102 may generate and communicate a new search response, and merchant user terminal 86 may display an updated metrics GUI 700.

Other users in addition to merchants may obtain the metrics. For example, deal providers may request the metrics, using communications similar to that discussed above in FIGS. 5-7, for benchmarking their performance against competing deal providers. Deal providers may also desire to have the metrics for touting the superiority of their service as compared to their competitors. For example, a first deal provider may obtain metrics to support an advertising claim that their service provides the greatest post-deal increase in spend per visit for moderately-priced Chinese restaurants in the San Francisco area. In another example, merchants and deal providers may specify one or more metric thresholds, and payment network server 102 may push alerts to a merchant and/or deal provider terminal when a threshold (e.g., a ceiling or a floor) for a metric is met or exceeded.

Additionally, it is noted that metrics are described above based on information derived in real-time during payment authorization. In other examples, the metrics may be derived based on payment amounts authorized during settlement, which may occur sometime after payment authorization. Authorized settlement payment amounts may be more reliable than authorized payment amounts for certain categories of merchants (e.g., restaurants, hotels). In fact, for these categories of merchants the system may only allow the use of settlement amounts in the generation of metrics to avoid reliance on potentially inflated data.

In some examples, consent may be obtained from an entity prior to analyzing and/or accessing data in accordance with the above-described embodiments. For example, a merchant, consumer, or other data owning entity, may be prompted to provide consent (e.g., opt-in) prior to having their data analyzed and/or accessed.

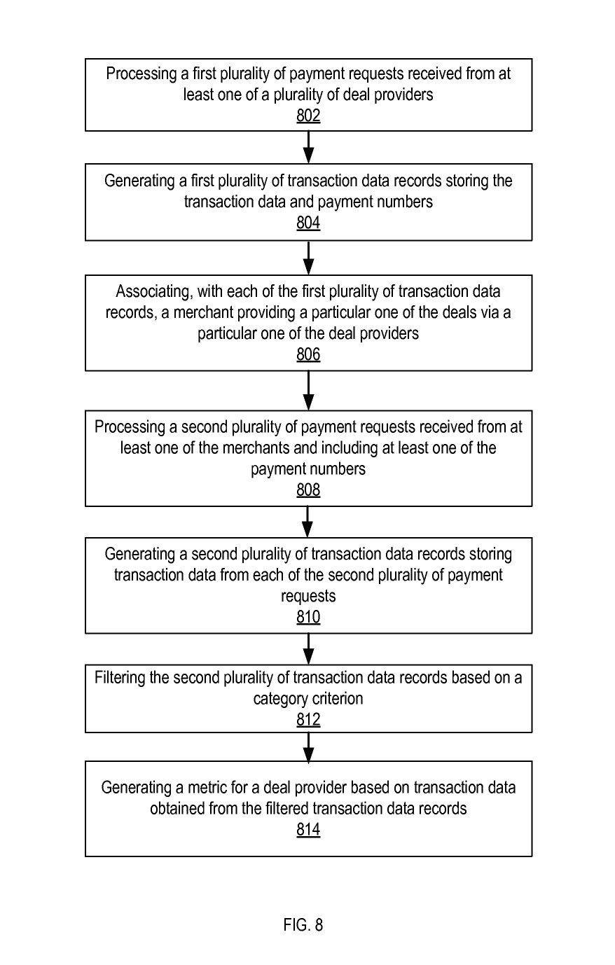

FIG. 8 illustrates a flow diagram of a method for generating a metric in accordance with example embodiments. The flow diagram may be implemented by a system or apparatus, such as, for example, payment network server 102. Each of the steps shown in the flow diagram may be repeated one or times, one or more of the steps may be modified, and one or more of the steps may be omitted. Unless otherwise noted or is plainly required by the context, the particular ordering of the blocks may also be modified. The method may be stored on a non-transitory computer readable medium as computer executable instructions. The computer executable instructions, when executed by at least one processor, may cause at least one computer or other device to perform the method one or more times. The flow diagram may begin at block 802.

In block 802, the method may include processing a first plurality of payment requests received from at least one of a plurality of deal providers, wherein each of the requests comprises transaction data associated with a deal listed by one of the deal providers and a payment number associated with a customer. In an example, with reference to FIGS. 1-3, payment network server 102 may receive payment authorization requests from a deal provider (e.g., via a deal provider website). Payment settlement requests may similarly be used instead of or in addition to payment authorization requests in this step and in the subsequent steps.

In block 804, the method may include generating a first plurality of transaction data records storing the transaction data and the payment numbers. In an example, with reference to FIGS. 2-3, payment network server 102 may extract transaction data and payment numbers (e.g., credit card numbers) from each of the requests for storage in database 104 as transaction data records.

In block 806, the method may include associating, with each of the first plurality of transaction data records, a merchant providing a particular one of the deals via a particular one of the deal providers. In an example, payment network server 102 may process a deal code included in the payment authorization requests to identify a merchant identifier associated with the deal code, and may include the merchant identifier in a corresponding transaction data record. In another example, payment network server 102 may identify available deals from a deal provider website to deduce a merchant identifier in the manner described above.

In block 808, the method may include processing a second plurality of payment requests received from at least one of the merchants and including at least one of the payment numbers. In an example, with reference to FIG. 4, payment network server 102 may receive, from one or more merchant servers 82 or point of sale terminals 88, payment authorization requests containing transaction data that includes a merchant identifier and a payment number that was previously used to purchase a deal from at least one of the deal providers.

In block 810, the method may include generating a second plurality of transaction data records storing transaction data from each of the second plurality of payment requests. In an example, payment network server 102 may extract the transaction data from payment authorization requests and may store a transaction data record in database 104.

In block 812, the method may include filtering the second plurality of transaction data records based on a category filter. In an example, payment network server 102 may receive a search query including at least one category filter. Payment network server 102 may apply the category filter to identify matching transaction records.

In block 814, the method may include generating a metric for a deal provider based on transaction data obtained from the filtered transaction data records. In an example, payment network server 102 may generate one or more metrics (e.g., average spend per visit after transaction date of deal) for one or more deal providers based on transaction data obtained from the filtered transaction data records.

The method in FIG. 8 may end, may repeat one or more times, or may return to any of the preceding blocks.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++ or Perl using, for example, conventional or object-oriented techniques. In some examples, the at least one processor may be specifically programmed.

The software code may be stored as a series of instructions, or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed (or physically configured) to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

The example embodiments may include the means described herein for performing the described functionality. In an example, an apparatus may include means for processing a first plurality of payment requests received from at least one of a plurality of deal providers, wherein each of the requests comprises transaction data associated with a deal listed by one of the deal providers and a payment number associated with a customer; means for generating a first plurality of transaction data records storing the transaction data and the payment numbers; means for associating, with each of the first plurality of transaction data records, a merchant providing a particular one of the deals via a particular one of the deal providers; means for processing a second plurality of payment requests received from at least one of the merchants and including at least one of the payment numbers; means for generating a second plurality of transaction data records storing transaction data from each of the second plurality of payment requests; means for filtering the second plurality of transaction data records based on a category filter; and means for generating a metric for at least one of the deal providers based on transaction data obtained from the filtered transaction data records. The apparatus may further include means for processing a search query comprising the category filter, wherein the category filter comprises at least one of a geographical filter, a merchant category filter, a product filter, a service filter, a customer type filter, a deal code filter, and a deal provider filter. The apparatus may also include means for processing an update to the category filter; means for filtering the second plurality of transaction data records based on the updated category filter to identify updated filtered transaction data records; and means for generating a second metric for at least one of the deal providers based on transaction data obtained from the updated filtered transaction data records. Additionally, the apparatus may include means for determining a merchant identifier based on: (1) a geographic zone of previous purchases using a particular one of the payment numbers; or (2) purchase history using a particular one of the payment numbers.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, system 100 and the methods described herein may be configured to automatically provide metrics for assessing the performance of competing deal providers. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. An apparatus comprising:
at least one processor; and
at least one memory storing computer executable instructions that, when executed by the at least one processor, cause the apparatus at least to perform:
processing a first plurality of payment requests received from at least one of a plurality of deal providers, wherein each of the requests comprises transaction data associated with a deal listed by one of the deal providers and a payment number associated with a customer;
generating a first plurality of transaction data records storing the transaction data and the payment numbers;
associating, with each of the first plurality of transaction data records, a merchant providing a particular one of the deals via a particular one of the deal providers;
processing a second plurality of payment requests received from at least one of the merchants and including at least one of the payment numbers;
generating a second plurality of transaction data records storing transaction data from each of the second plurality of payment requests;
filtering the second plurality of transaction data records based on a category filter; and
generating a metric for at least one of the deal providers based on transaction data obtained from the filtered second plurality of transaction data records.

2. The apparatus of claim 1, wherein the computer executable instructions, when executed by the at least one processor, further cause the apparatus to process a search query comprising the category filter.

3. The apparatus of claim 1, wherein the category filter comprises at least one of a geographical filter, a merchant category filter, a product filter, a service filter, a customer type filter, a deal code filter, and a deal provider filter.

4. The apparatus of claim 1, wherein the computer executable instructions, when executed by the at least one processor, further cause the apparatus to:
process an update to the category filter;
filter the second plurality of transaction data records based on the updated category filter to identify updated filtered transaction data records; and
generate a second metric for the at least one of the deal providers based on transaction data obtained from the updated filtered transaction data records.

5. The apparatus of claim 1, wherein the metric comprises expenditure information by customers at a particular merchant prior and subsequent to a transaction date associated with a deal.

6. The apparatus of claim 1, wherein the computer executable instructions, when executed by the at least one processor, further cause the apparatus to determine a merchant identifier based on a deal code included in at least one of the first plurality of payment requests.

7. The apparatus of claim 1, wherein the computer executable instructions, when executed by the at least one processor, further cause the apparatus to determine a merchant identifier based on a geographic zone of previous purchases using a particular one of the payment numbers.

8. The apparatus of claim 1, wherein the computer executable instructions, when executed by the at least one processor, further cause the apparatus to determine a merchant identifier based on purchase history using a particular one of the payment numbers.

9. The apparatus of claim 1, wherein the metric compares performance of at least two of the deal providers within a particular category of merchants.

10. An apparatus comprising:
means for processing a first plurality of payment requests received from at least one of a plurality of deal providers, wherein each of the requests comprises transaction data associated with a deal listed by one of the deal providers and a payment number associated with a customer;
means for generating a first plurality of transaction data records storing the transaction data and the payment numbers;
means for associating, with each of the first plurality of transaction data records, a merchant providing a particular one of the deals via a particular one of the deal providers;
means for processing a second plurality of payment requests received from at least one of the merchants and including at least one of the payment numbers;
means for generating a second plurality of transaction data records storing transaction data from each of the second plurality of payment requests;
means for filtering the second plurality of transaction data records based on a category filter; and
means for generating a metric for at least one of the deal providers based on transaction data obtained from the filtered second plurality of transaction data records.

11. The apparatus of claim 10, further comprising means for processing a search query comprising the category filter, wherein the category filter comprises at least one of a geographical filter, a merchant category filter, a product filter, a service filter, a customer type filter, a deal code filter, and a deal provider filter.

12. The apparatus of claim 10, further comprising:
means for processing an update to the category filter;
means for filtering the second plurality of transaction data records based on the updated category filter to identify updated filtered transaction data records; and
means for generating a second metric for at least one of the deal providers based on transaction data obtained from the updated filtered transaction data records.

13. The apparatus of claim 10, wherein the metric comprises expenditure information by customers at a particular merchant prior and subsequent to a transaction date associated with a deal.

14. The apparatus of claim 10, further comprising means for determining a merchant identifier based on:
(1) a geographic zone of previous purchases using a particular one of the payment numbers; or
(2) purchase history using a particular one of the payment numbers.

15. The apparatus of claim 10, wherein the metric compares performance of at least two of the deal providers within a particular category of merchants.

16. A computer-implemented method comprising:
processing, by at least one specifically programmed processor, a first plurality of payment requests received from at least one of a plurality of deal providers, wherein each of the requests comprises transaction data associated with a deal listed by one of the deal providers and a payment number associated with a customer;
generating, by the at least one specifically programmed processor, a first plurality of transaction data records storing the transaction data and the payment numbers;
associating, with each of the first plurality of transaction data records, by the at least one specifically programmed processor, a merchant providing a particular one of the deals via a particular one of the deal providers;
processing, by the at least one specifically programmed processor, a second plurality of payment requests received from at least one of the merchants and including at least one of the payment numbers;
generating, by the at least one specifically programmed processor, a second plurality of transaction data records storing transaction data from each of the second plurality of payment requests;
filtering, by the at least one specifically programmed processor, the second plurality of transaction data records based on a category filter; and
generating, by the at least one specifically programmed processor, a metric for at least one of the deal providers based on transaction data obtained from the filtered second plurality of transaction data records.

17. The method of claim 16, further comprising:
processing an update to the category filter;
filtering the second plurality of transaction data records based on the updated category filter to identify updated filtered transaction data records; and
generating a second metric for the at least one of the deal providers based on transaction data obtained from the updated filtered transaction data records.

18. The method of claim 16, further comprising determining a merchant identifier based on a deal code included in at least one of the first plurality of payment requests.

19. The method of claim 16, further comprising determining a merchant identifier based on a geographic zone of previous purchases using a particular one of the payment numbers.

20. The method of claim 16, further comprising determining a merchant identifier based on purchase history using a particular one of the payment numbers.
